(19) United States
(12) Patent Application Publication
(10) Pub. No.: US 2009/0108106 A1
(43) Pub. Date: Apr. 30, 2009

(54) FUEL INJECTOR WITH HYDRAULIC DAMPING

(75) Inventors: Franco CIAMPOLINI, Bologna (IT); Andrea RICCI, Casalecchio Di Reno (IT); Massimo ARMAROLI, Monte San Pietro (IT); Luca GUSMERINI, Valmadonna (IT); Bruno MONTEVERDE, Bologna (IT)

Correspondence Address: GOTTLIEB RACKMAN & REISMAN PC, 270 MADISON AVENUE, 8TH FLOOR, NEW YORK, NY, 10016-0601, US

(73) Assignee: MAGNETI MARELLI HOLDING S.p.A., Corbetta (IT)

(21) Appl. No.: 12/259,655

(22) Filed: Oct. 28, 2008

(30) Foreign Application Priority Data
Oct. 29, 2007 (EP) 07425677.7

(51) Int. Cl. F02M 61/00

(52) U.S. Cl. 239/533.12

(57) ABSTRACT

A fuel injector provided with: an injection valve comprising an injection nozzle; a movable plunger for adjusting the flow of fuel through the injection valve and ending in a shutting head which engages a valve seat of the injection valve; an actuator for displacing the plunger between a closing position and an opening position of the injection valve; an annular backing element which constitutes an upper stroke end of the plunger and defines the opening position; and a hydraulic damping device which is adapted to generate on the plunger a hydraulic force which opposes the movement of the plunger towards the opening position when the plunger itself is close to the backing element.

### TECHNICAL FIELD

This application claims priority from European Patent Application No. 07425677.7 filed Oct. 29, 2007. The present invention relates to a fuel injector.

The present invention finds an advantageous application for an electromagnetic injector, to which explicit reference will be made in the following description without therefore loosing in generality.

### BACKGROUND ART

A fuel injector comprises a cylindrical tubular accommodating body having a central feeding channel, which functions as fuel pipe and ends with an injection nozzle adjusted by an injection valve controlled by an electromagnetic actuator. The injection valve is provided with a plunger, which is rigidly connected to a movable keeper of the electromagnetic actuator to be displaced by the action of the electromagnetic actuator itself between a closing position and an opening position of the injection nozzle against the bias of a closing spring which tends to maintain the plunger in the closing position. The plunger ends with a shutting head which, in the closing position, is biased by the closing spring against the valve seat of the injection valve to prevent the leakage of fuel.

The closing position of the plunger is defined by the contact of the shutting head against the valve seat of the injection valve, i.e. the contact of the shutting head against the valve seat of the injection valve constitutes a lower stroke end of the plunger. The opening position of the plunger is defined by the contact between a portion of the plunger and a backing element which constitutes the upper stroke end of the plunger.

When the injector is driven to inject the fuel, the plunger is displaced from the closing position to the opening position thus performing an opening stroke; at the end of the opening stroke, the plunger strikes the backing element which constitutes the upper stroke end; upon this collision, the plunger rebounds and thus strikes the backing element again at slower speed rebounding again and so on. In other words, a damped oscillatory motion is established, which after a few cycles leads the plunger to arrange itself stationary in contact with the backing element which constitutes the upper stroke end.

The above-described rebounding of the plunger against the backing element which constitutes the upper stroke end does not essentially cause any negative consequence when the injector is kept open for a relatively long injection time (i.e. for an injection time longer than the time needed for the oscillatory behaviour triggered by the rebound to be exhausted) because when the plunger is returned to the closing position the oscillatory behaviour triggered by the rebound is almost exhausted. Instead, the above-described rebounding phenomenon of the plunger against the backing element which constitutes the upper stroke end introduces a high uncertainty in the injected fuel amount when the injector is kept open for a short injection time (i.e. for an injection time shorter than the time needed for the oscillatory behaviour triggered by the rebound to be exhausted) because when the plunger is returned to the closing position the oscillatory behaviour triggered by the rebound has not yet been exhausted.

During the oscillatory behaviour triggered by the rebound, the plunger may have either a positive speed (i.e. may be displaced towards the opening position moving away from the closing position) with a variable value or may have a negative speed (i.e. may be displaced towards the closing position moving away from the opening position) with a variable value. When the closing command is imparted during the oscillatory behaviour triggered by the rebound, the plunger may have either a positive speed which opposes the closing or a negative speed which promotes the closing in an uncertain manner (i.e. not predictable a priori); in both cases, the closing times are considerably different and thus, with the opening time of the plunger being equal, the fuel amount which is injected may vary randomly in a manner not predictable a priori.

It is worth emphasizing that the oscillatory behaviour triggered by the rebound is affected by various factors which are difficult to predict and however displays a certain randomness; consequently, the oscillatory behaviour triggered by the rebound is essentially uncertain and thus cannot be accurately predicted a priori and cannot be compensated a posteriori, e.g. by compensating the injection times.

As previously described, by effect of the oscillatory behaviour triggered by the rebound, for short injection times, the fuel amount which is injected may vary randomly in a manner not predictable a priori; consequently, for short injection times, the injection time/injected fuel amount characteristic displays a pronounced lack of linearity and a high randomness (i.e. lack of repeatability). Such a lack of linearity and repeatability for short injection times is particularly harmful in modern internal combustion engines, in which a punctual and very accurate torque control is required in order to effectively perform traction and vehicle stability controls.

### DISCLOSURE OF INVENTION

It is the object of the present invention to make a fuel injector which is free from the above-described drawbacks and is specifically easy and cost-effective to manufacture.

According to the present invention, a fuel injector is made as recited in the attached claims.

### BRIEF DESCRIPTION OF THE DRAWINGS

The present invention will now be described with reference to the accompanying drawings, which illustrate some non-limitative embodiments thereof, in which:

FIG. 1 is a diagrammatic, side section view with parts removed for clarity of a fuel injector made according to the present invention;

FIG. 2 shows a detail of the fuel injector in FIG. 1 on an enlarged scale;

FIG. 3 shows the injection time/injected fuel amount characteristic of a standard fuel injector; and

FIG. 4 shows the injection time/injected fuel amount characteristic of the fuel injector in FIG. 1.

### BEST MODE FOR CARRYING OUT THE INVENTION

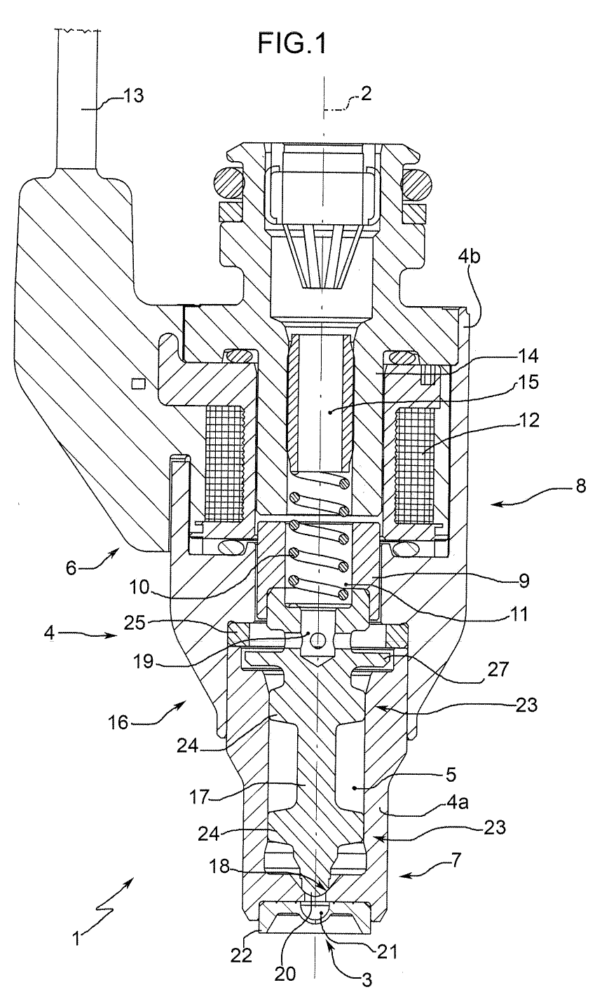

In FIG. 1, numeral 1 indicates as a whole a fuel injector, which essentially displays a cylindrical symmetry about a longitudinal axis 2 and which is controlled to inject fuel from an injection nozzle 3. The injector 1 comprises a supporting body 4, which has a cylindrical tubular shape of variable section along the longitudinal axis 2 and has a feeding channel 5 extending along its entire length to feed the pressurized fuel to the injection nozzle 3. The supporting body 4 accommodates an electromagnetic actuator 6 at an upper portion thereof and an injection valve 7 which delimits the lower end of the feeding channel 5 at a lower portion thereof; in use, the injection valve 7 is actuated by the electromagnetic actuator 6 to adjust the fuel flow through the injection nozzle 3, which is obtained at the injection valve 7 itself.

Preferably, the supporting body 4 consists of an upper portion 4b accommodating the electromagnetic actuator 6 and a lower portion 4a accommodating the injection valve 7 which are jointed together by welding.

The electromagnetic actuator 6 comprises an electromagnet 8, which is accommodated in a fixed position within the supporting body 4 and when energized displaces a movable keeper 9 of ferromagnetic material along the axis 2 from a closing position to an opening position of the injection valve 7 against the bias of a closing spring 10 which tends to maintain the movable keeper 9 in the closing position of the injection valve 7. The movable keeper 9 has a central axial through hole 11 (i.e. parallel to the longitudinal axis 2) to allow the flow of fuel towards the injection nozzle 3. The electromagnet 8 further comprises a coil 12 which is electrically energized by an electronic control unit (not shown) by means of an electric wire 13 and a fixed magnetic yoke 14, which is accommodated inside the supporting body 4 and has a central axial through hole 15 (i.e. parallel to the longitudinal axis 2) for allowing the fuel flow towards the injection nozzle 3.

The movable keeper 9 is part of a moving element 16, which further comprises a shutter or plunger 17, having an upper portion integral with the movable keeper 9 and a lower portion cooperating with a valve seat 16 of the injection valve 7 to adjust the fuel flow through the injection nozzle 3 in a known manner. An upper portion of the plunger 17 arranged at the movable keeper 9 has a feeding hole 19, which is elbow-shaped and has an upper axial inlet and four lower radial outlets (only three of which are shown in FIG. 1); the fuel passing through the central hole 11 of the movable keeper 9 enters into the feeding hole 19 of the plunger 17 through the upper axial inlet and then exits from the feeding hole 19 of the plunger 17 through the lower radial outlets. According to the embodiment shown in the accompanying figures, the feeding hole 19 consists of a first axial hole which defines the upper axial inlet and four radial holes arranged as a cross which define the lower radial outlets.

As per the foregoing description, it is apparent that upstream of the feeding hole 19 of the plunger 17 the fuel flows through the feeding channel centrally, while downstream of the feeding hole 19 of the plunger 17 the fuel flows through the feeding channel sideways. Obviously, in order to allow the fuel to flow through the feeding channel sideways, the external diameter of the plunger 17 is smaller than the internal diameter of the feeding channel 5.

The plunger 17 ends with a shutting head 20, which is adapted to tightly rest against the valve seat 18 having a shape which negatively reproduces the shape of shutting head 20 itself. Downstream of the valve seat 18 a semi-spherical injection chamber 21 is obtained, which is crossed by at least one through hole which defines the injection nozzle 3 and is formed by a plate 22 which is welded to the supporting body 4.

The movable keeper 9 of the electromagnet 8 is annular shaped and has a smaller diameter than the internal diameter of the corresponding portion of the feeding channel 5 of the supporting body 4, and consequently the movable keeper 9 may not function as upper guide of the plunger 17 as well. According to the embodiment shown in FIG. 1, the plunger 17 comprises a pair of guiding elements 23, which are reciprocally and axially spaced and function as upper and lower guide of the plunger 17. Each guiding element 23 has bulges 24 (only two of which are shown in FIG. 1) having an external diameter equal to the internal diameter of the feeding channel 5; typically, each guiding element 23 has three or four bulges 24 symmetrically distributed as a triangle or cross. Obviously, the fuel may flow towards the injection nozzle 3 passing through the void between the bulges 24.

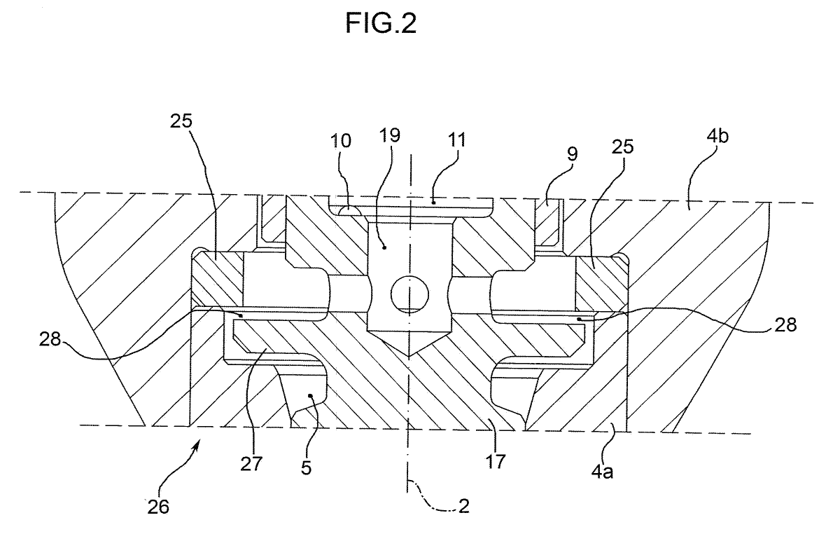

As shown in FIG. 2, there is an annular shaped backing element 25 which is arranged inside the feeding channel 5, constitutes an upper stroke end of the plunger 17 and defines the opening position; in other words, the opening movement of the plunger 17 is stopped in the opening position by effect of the action of the backing element 25 as will be described in detail below. The lower stroke end of the plunger 17 which defines the closing position is the valve seat 18 against which the closing movement of the plunger 17 stops.

Furthermore, the injector 1 comprises a hydraulic damping device 26 which is adapted to generate a hydraulic force on the plunger 17, which force opposes the movement of the plunger 17 towards the opening position when the plunger 17 itself is close to the backing element 25. According to a preferred embodiment, when the plunger 17 is close to the backing element 25, the hydraulic damping device 26 is adapted to generate on the plunger 17 a sufficiently high hydraulic force which opposes the movement of the plunger 17 towards the opening position so as to balance the force exerted on the plunger 17 by the actuator 6 and to stop the movement of the plunger 17 before the plunger 17 strikes the backing element 25.

In other words, when the plunger 17 approaches the backing element 25 at the end of the opening movement, the hydraulic damping device 26 generates on the plunger 17 a hydraulic force which opposes the movement of the plunger 17 towards the opening position and progressively increases (i.e. the more the plunger 17 approaches the backing element 25 the higher is such hydraulic force) until the force exerted on the plunger 17 by the actuator 6 is completely balanced so as to stop the movement of the plunger 17 before the plunger 17 strikes the backing element 25. It is worth emphasizing that in order to prevent the plunger 17 from striking the backing element 25, such a hydraulic force must balance both the force exerted on the plunger 17 by the actuator 6 and the inertial force (i.e. deriving from kinetic energy) which the plunger 17 has by effect of the movement towards the opening position.

According to a different embodiment, the hydraulic damping device 26 could generate on the plunger 17 a hydraulic force which opposes the movement of the plunger 17 towards the opening position and which slows down the plunger 17 close to the backing element 25 without however preventing the collision (at slow speed) of the plunger 17 against the backing element 25.

According to the preferred embodiment shown in FIG. 2, the hydraulic damping device 26 comprises a plate 27, which is integral with the plunger 17 and has an external crown facing the backing element 25 so as to define with the backing element 25 itself an annular fuel passage 28 which displays a progressively decreasing section as the plunger 17 advances towards the opening position. The hydraulic force which opposes the movement of the plunger 17 towards the opening position is generated by effect of the gradual increase of the load loss (pressure difference) which is progressively established in the annular fuel passage 28 as the section of the annular passage 28 is reduced by effect of the approach of the plate 27 to the backing element 25. In other words, the function of the plate 27 is to create the annular fuel passage 28, which displays a progressively decreasing section as the plunger 17 advances towards the opening position (i.e. towards the backing element 25); the considerable increase of the pressure drop (in the size order of some bars when the fuel feeding pressure to the injector 1 is approximately 100 bars) which is established in the annular fuel passage 28, as the section of the annular passage 28 is reduced by effect of the approaching of the plate 27 to the backing element 25, generates a hydraulic force which opposes the movement of the plunger 17 towards the opening position.

Preferably, an axial dimension (i.e. along the longitudinal axis 2) of the gap existing between the movable keeper 9 and the fixed magnetic yoke 14 is such as to be always higher than the length of the stroke of the plunger 17 limited by the backing element 25 in order to guarantee that the length of the stroke is determined by the backing element 25 and not by the abutment of the movable keeper 9 against the fixed magnetic yoke 14. From the above, it is apparent that the gap existing between the movable keeper 9 and the fixed magnetic yoke 14 is never cancelled (therefore avoiding magnetic sticking phenomena between the movable keeper 9 and the magnetic yoke 14), because the movable keeper 9 never comes into contact with the fixed magnetic yoke 14; obviously, during the step of designing the electromagnet 8, the influence of the gap which displays a larger dimension than a traditional electromagnetic injector must be taken into consideration.

In use, when the electromagnet 8 is not energized, the movable keeper 9 is not attracted by the fixed magnetic yoke 14 and the elastic force of the closing spring 10 biases the movable keeper 9 along with the plunger 17 downwards so as to keep the plunger 17 in the closing position; in this situation, the shutting head 20 of the plunger 17 is pressed against the valve seat 18 of the injection valve 7, preventing the leakage of fuel. When the electromagnet 8 is energized, the movable keeper 9 is magnetically attracted by the fixed magnetic yoke 14 against the elastic force of the closing spring 10 and the movable keeper 9 along with the plunger 17 is displaced upwards until the movement of the plunger 17 is stopped in the opening position by the action of the hydraulic damping device 26 as previously described; in this situation, the movable keeper 9 is separated from the fixed magnetic yoke 14, the shutting head 20 of the plunger 17 is lifted with respect to the valve seat 18 of the injection valve 7, and the pressurized fuel may flow through the injection nozzle 3.

The movement of the plunger 17 is ruled by the following equation which is thus used to dimension the damping device 26:

M·\ddot{X}(t)=F_{MG}(t,X(t))+F_{M}(X(t))+F_{IDR}(X(t))+F_{V}(\dot{X}(t))+R(t)
M mass of the plunger 17;
X position of the plunger 17;
F_{MG} force exerted on the plunger 17 by the electromagnet 8 according to time and to the position of the plunger 17;
F_{M} force exerted on the plunger 17 by the action of the spring 10 according to the position of the plunger 17;
F_{IDR} hydraulic force acting on the plunger 17 (sum of the contributions of all the pressure differentials, including that appropriately induced by the hydraulic damper 26) according to the position of the plunger 17;
F_{V} viscous force acting on the plunger 17 according to the speed of the plunger 17;
R constraining reaction acting on the plunger 17 due to the contact between the plunger 17 and the two stroke ends (for intermediate positions between the two stroke ends, the constraining reaction acting on the plunger 17 is null).

It has been observed that with the dimensions of the plate 27 being equal, the residual height (i.e. the axial dimension measured along the longitudinal axis 2 when the plunger 17 is stopped in the opening position) of the annular fuel passage 28 increases if the feeding fuel pressure increases, increases if the static flow rate of the injected fuel increases, increases if the elastic force generated by the closing spring 10 increases, and increases if the magnetic force generated by the minimum gap electromagnet 8 decreases (i.e. when the plunger 17 is stopped in the opening position).

Furthermore, it has been observed that with the fuel feeding being equal, the injected fuel static flow rate being equal, and the elastic force generated by the closing spring 10 being equal, an increase of the external diameter of the plate 27 and correspondingly of the internal diameter of the backing element 25 confers greater stability to the system, i.e. the oscillations of the plunger 17 about the opening position (i.e. the maximum lifting) are reduced.

In virtue of the action of the hydraulic damping device 26, the plunger 17 at the end of the opening stroke does not strike the backing element 25 and therefore is not subjected to any type of rebound (alternatively, the plunger 17 could strike against the backing element 25 at very slow speed and thus with a very small and then essentially negligible rebound). In this manner, no oscillatory behaviour triggered by a rebound occurs and also for small injection times the fuel amount which is injected is directly proportional to the injection time (i.e. to the opening time of the injector 1) without any random variation which are not predictable a priori). Therefore, also for short injection times, the injection time/injected fuel amount characteristic displays a high linearity and repeatability.

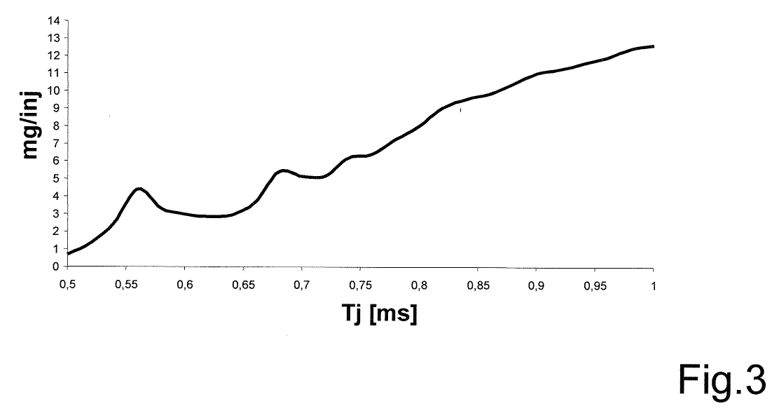

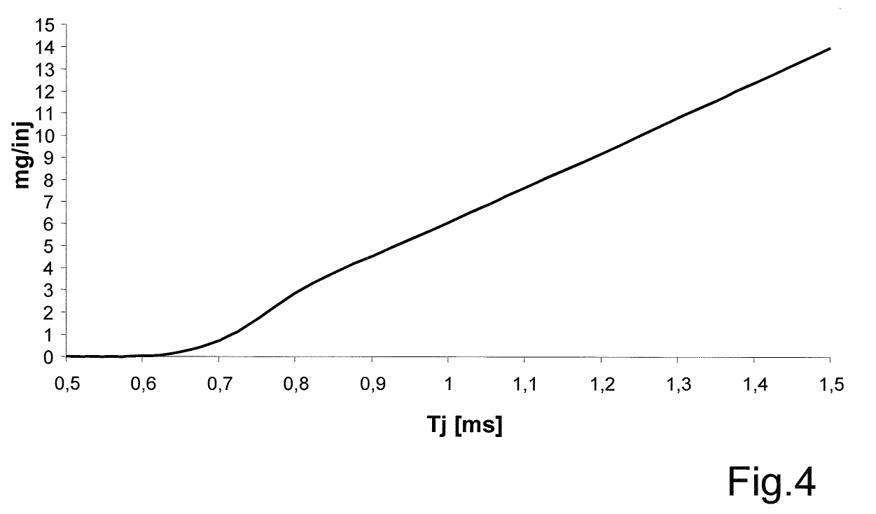

The foregoing is well highlighted by comparing the chart in FIG. 3 which shows the injection time/injected fuel amount characteristic of a standard fuel injector and the chart in FIG. 4 which shows the injection time/injected fuel amount characteristic of the fuel injector 1 described above. It is noted that the injection time/injected fuel amount characteristic of a standard fuel injector displays pronounced non-linearities for short injection times, while the injection time/injected fuel amount characteristic of the above-described fuel injector 1 is nearly perfectly linear for short injection times as well.

Furthermore, the absence of collision between the plunger 17 (specifically between the plate 27 integral with the plunger 17) and the backing element 25 reduces the mechanical wear of the two components themselves and does not require the external surfaces of such components to be treated to increase their mechanical resistance. Consequently, the above-described injector 1 displays a particularly long working life, displays reduced settling times (i.e. run-in times for stabilizing its own features) and is also cost-effective to manufacture.

Finally, as there is no contact between the plunger 17 (specifically between the plate 27 integral with the plunger 17) and the backing element 25, there is no hydraulic sticking phenomenon between the plunger 17 and the backing element 25. Consequently, the above-described injector 1 is also very quick to close once the attraction action of the electromagnet 8 is interrupted.

1. A fuel injector (1) comprising:
an injection valve (7) comprising an injection nozzle (3);
a movable plunger (17) for adjusting the flow of fuel through the injection valve (7) and ending in a shutting head (20) which engages a valve seat (18) of the injection valve (7);
an actuator (6) for displacing the plunger (17) between a closing position and an opening position of the injection valve (7); and
a backing element (25) which constitutes an upper stroke end of the plunger (17) and defines the opening position;
the injector (1) is characterized in that it comprises a hydraulic damping device (26) which is adapted to generate on the plunger (17) a hydraulic force which opposes the movement of the plunger (17) towards the opening position when the plunger (17) itself is close to the backing element (25).

2. An injector (1) according to claim 1, wherein when the plunger (17) is close to the backing element (25), the hydraulic damping device (26) is adapted to generate on the plunger (17) a sufficiently high hydraulic force which opposes the movement of the plunger (17) towards the opening position so as to balance the force exerted on the plunger (17) by the actuator (6) and to stop the movement of the plunger (17) before the plunger (17) strikes the backing element (25).

3. An injector (1) according to claim 1, wherein the hydraulic damping device (26) comprises a plate (27), which is integral with the plunger (17) and has an external crown facing the backing element (25) so as to define with the backing element (25) itself an annular fuel passage (28) which displays a progressively decreasing section as the plunger (17) advances towards the opening position.

4. An injector (1) according to claim 1, wherein the actuator (6) comprises a spring (10) which biases the plunger (17) towards the closing position.

5. An injector (1) according to claim 4, wherein the actuator (6) is of the electromagnetic type and comprises at least one coil (12), at least one fixed magnetic yoke (14), and at least one movable keeper (9), which is magnetically attracted by the fixed magnetic yoke (14) against the bias of the spring (10) and is mechanically connected to the plunger (17).

6. An injector (1) according to claim 5, wherein an axial dimension of the gap existing between the movable keeper (9) and the fixed magnetic yoke (14) is such as to be always higher than the length of the stroke of the plunger (17) limited by the backing element (25) in order to guarantee that the length of the stroke is determined by the backing element (25) and not by the abutment of the movable keeper (9) against the fixed magnetic yoke (14).

7. An injector (1) according to claim 1 and comprising a supporting body (4), which has a variable section tubular cylindrical shape and has a feeding channel (5) delimited at its lower end by the injection valve (7); the plunger (17) is arranged inside the feeding channel (5), displays an external diameter smaller than the internal diameter of the feeding channel (5) and comprises a pair of reciprocally spaced guiding elements (23) each of which has bulges (24) having an external diameter equal to the internal diameter of the feeding channel (5).

8. An injector (1) according to claim 1, wherein an upper portion of the plunger (17) has a feeding hole (19), which is elbow-shaped and which has at least one axial inlet and at least one radial outlet.

9. An injector (1) according to claim 8, wherein the feeding hole (19) has an axial inlet and a plurality of radial outlets.
